(19) United States
(12) Patent Application Publication
(10) Pub. No.: US 2007/0058275 A1
(43) Pub. Date: Mar. 15, 2007

(54) Tail mirror for an automobile

(75) Inventor: Wei-Che Chen, Yen-Pu Hsiang (TW)

Correspondence Address: MCNEES, WALLACE & NURICK LLC, 100 PINE STREET, P.O. BOX 1166, HARRISBURG, PA, 17108-1166, US

(73) Assignee: KEN SEAN FACTORY CO., LTD., Fu-Hsing Hsiang (TW)

(21) Appl. No.: 11/340,238

(22) Filed: Jan. 26, 2006

(30) Foreign Application Priority Data
Sep. 14, 2005 (TW) 094215819

(51) Int. Cl. G02B 7/182

(52) U.S. Cl. 359/876; 359/872

(57) ABSTRACT

A tail mirror for an automobile includes a mirror holder having a holder pivot portion, a mounting base having a base pivot portion, an adjustment seat disposed between the holder and base pivot portions, and first and second adjusters. The first adjuster connects the adjustment seat to the holder pivot portion, the holder pivot portion being rotatable relative to the adjustment seat about a first pivot axis, the first adjuster being operable to limit or permit rotational movement of the holder pivot portion. The second adjuster connects the adjustment seat to the base pivot portion, the base pivot portion being rotatable relative to the adjustment seat about a second pivot axis which is substantially perpendicular to the first pivot axis, the second adjuster being operable to limit or permit rotational movement of the base pivot portion.

### CROSS-REFERENCE TO RELATED APPLICATION

This application claims the priority of Taiwanese Application No. 094215819 filed Sep. 14, 2005.

### BACKGROUND OF THE INVENTION

1. Field of the Invention

The present invention relates to a tail mirror for an automobile, more particularly to a ground-view mirror to be mounted at the rear of an automobile to enable the driver to view the rear end of the automobile in the vicinity of the rear tires.

2. Description of the Related Art

As shown in FIG. 1, the conventional tail mirror, i.e., the ground-view mirror 100 normally mounted at the rear end of the automobile, has the main function of making it convenient for the driver, before starting the automobile, to view the blind spots behind the automobile which cannot be viewed with the interior rearview mirror and the exterior rearview mirror. Thus, such tail mirror is an accessory mirror installed for safe driving. In view of the current emphasis on travel safety, such tail mirror is gradually becoming a peripheral installation required in automobiles.

FIG. 2 shows one of the drawings in Taiwanese patent publication no. 517658 entitled, “Rear ground-view mirror.” This Taiwanese patent discloses a rear ground-view mirror for automobile that is currently in use, which comprises a cover 1, a mirror 2 and at least one fixing member 3. The cover 1 is formed by two side plates 11,12 and a back plate 13 defining an opening 14 into which the mirror 2 is received. The mirror 2 is rotatably disposed between the two side plates 11,12 through the fixing member 3 which has an external screw connection part. When the fixing member 3 is loosened to unlock the mirror 2, the mirror 2 can be turned angularly. When the fixing member 3 is tightened to lock the mirror 2, the mirror 2 is fixed in position. In this way, the viewable angle of the mirror 2 can be adjusted as necessary by a user, and the field of view can still be adjusted after the mirror has been installed.

However, the rear ground-view mirror disclosed in the aforementioned TW patent can only be turned about a single axis so that the field of view can be only varied in upward and downward directions, and cannot be adjusted leftward and rightward. Further, since such mirror is installed at the rear end of the automobile as an accessory device, such mirror might be fixed to the rear end of the automobile not by a mechanical locking connection but simply by adhesive attachment. Therefore, for a mirror of this type, apart from the importance of field of view adjustment, the overall weight is a consideration since a heavy mirror as manufactured cannot be easily and securely mounted to an automobile.

### SUMMARY OF THE INVENTION

Accordingly, a general object of the present invention is to solve the above drawbacks of the prior art.

A more specific object of the present invention is to provide a tail mirror for an automobile which is of a lightweight design and the field of view of which can be adjusted about two perpendicular axes.

To attain the above object, there is provided a tail mirror for an automobile comprising a mirror holder including a holder pivot portion; a mounting base having a base pivot portion; an adjustment seat disposed between the holder and base pivot portions; a first adjuster connecting the adjustment seat to the holder pivot portion, the holder pivot portion being rotatable relative to the adjustment seat about a first pivot axis, the first adjuster being operable to limit or permit rotational movement of the holder pivot portion; and a second adjuster connecting the adjustment seat to the base pivot portion, the base pivot portion being rotatable relative to the adjustment seat about a second pivot axis which is substantially perpendicular to the first pivot axis, the second adjuster being operable to limit or permit rotational movement of the base pivot portion.

### BRIEF DESCRIPTION OF THE DRAWINGS

Other features and advantages of the present invention will become apparent in the following detailed description of the preferred embodiment with reference to the accompanying drawings, in which:

FIG. 1 is a schematic view of a conventional rear ground-view mirror in the operational state as mounted on an automobile;

FIG. 2 shows another conventional rear ground-view mirror disclosed in Taiwanese patent publication no. 517658;

FIG. 3 is a plan view of a preferred embodiment of the tail mirror according to the present invention;

FIG. 4 is a side view of the preferred embodiment;

FIG. 5 is a sectional side view taken from line I-I of FIG. 3, showing the operation of the first adjuster to limit rotational movement of the holder pivot portion relative to the adjustment seat;

FIG. 6 is a sectional view similar to that in FIG. 5, showing the operation of the first adjuster to permit rotational movement of the holder pivot portion relative to the adjustment seat;

FIG. 7 is a sectional view taken along line II-II of FIG. 3, showing the operation of the second adjuster to limit rotational movement of the base pivot portion relative to the adjustment seat;

FIG. 8 is a sectional view similar to FIG. 7, but showing the operation of the second adjuster to permit rotational movement of the base pivot portion relative to the adjustment seat; and

FIG. 9 shows the operational position of the tail mirror in use.

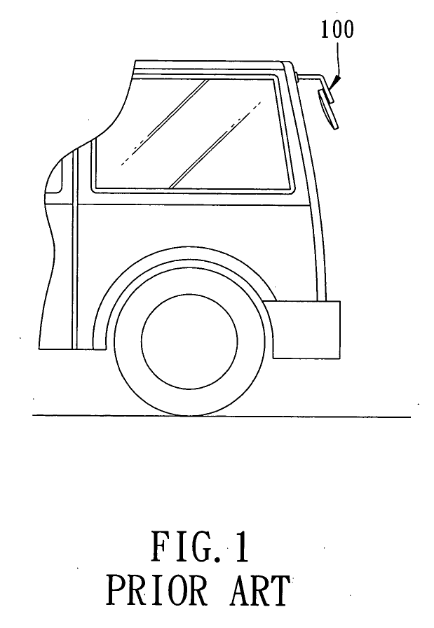

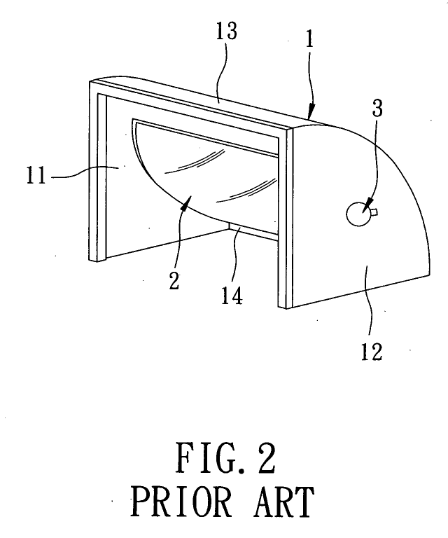

### DETAILED DESCRIPTION OF THE PREFERRED EMBODIMENT

The construction of a preferred embodiment of the tail mirror according to the present invention will now be described in greater detail below.

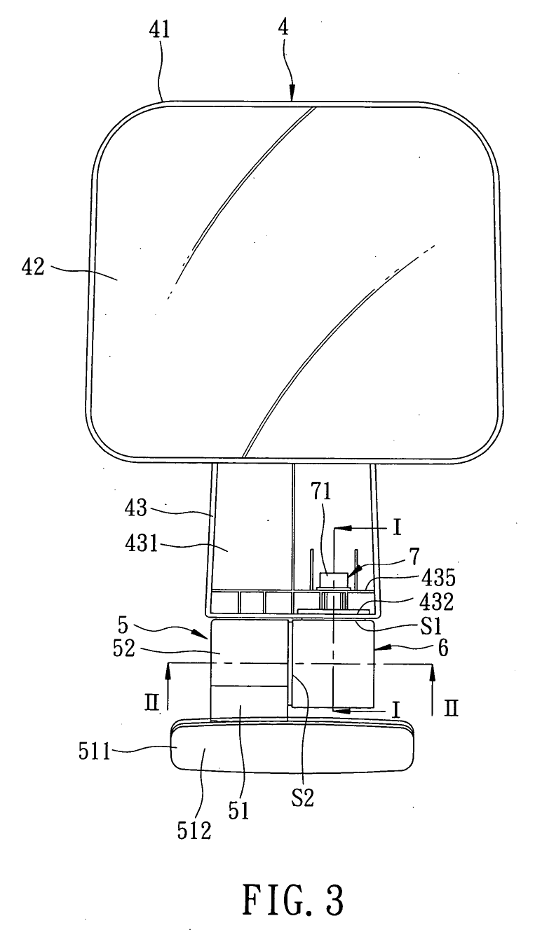

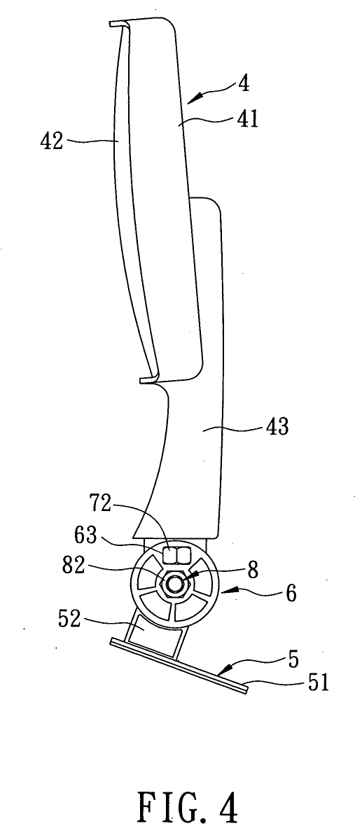

With reference to FIGS. 3 and 4, a tail mirror for an automobile according to a preferred embodiment of the present invention comprises a mirror holder 4, a mounting base 5, an adjustment seat 6, a first adjuster 7 and a second adjuster 8.

The mirror holder 4 includes a mirror frame 41 onto which a mirror 42 is mounted, and a holder pivot portion 43 extending from the mirror frame 41. The holder pivot portion 43, as shown in FIG. 5 in cross section, is formed by a holder frame 431 extending from a side of the mirror frame 41, a holder base plate 432 connected to the holder frame 431 and a rib plate 435 formed on the holder frame 431 above the holder base plate 432. A through-hole 433 is formed in the holder base plate 432, and another through-hole 436, which is in alignment with the through-hole 433, is formed in the rib plate 435.

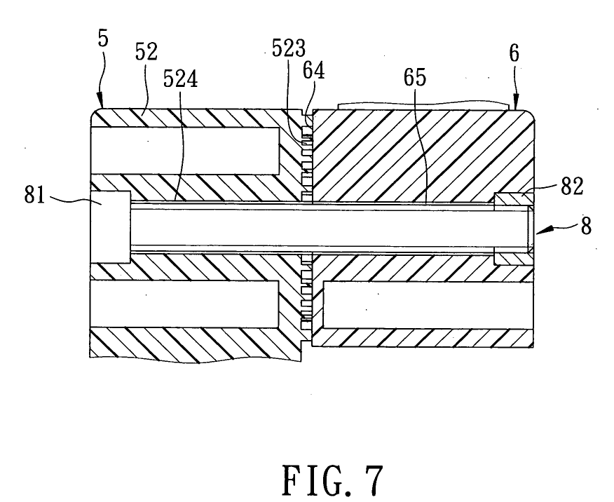

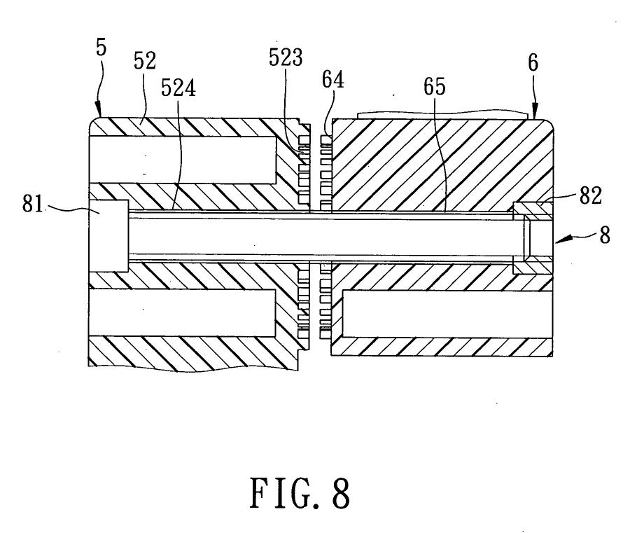

Referring to FIG. 7 or 8, the mounting base 5 includes a support portion 51 and a base pivot portion 52 extending from the support portion 51. The support portion 51 includes a mounting base plate 511 having one side from which the base pivot portion 52 projects and another free side onto which an adhesive layer 512 is disposed. The base pivot portion 52 extends from the base plate 511 and has a bore 524.

The adjustment seat 6 is disposed between the holder pivot portion 43 and the base pivot portion 52 and serves as a connection between the mirror holder 4 and the mounting base 5. In the preferred embodiment, the adjustment 6 is arranged in juxtaposition with the base pivot portion 52 between the support portion 51 and the mirror holder 4, and has a first side S1 confronting the holder pivot portion 43 and a second side S2, substantially perpendicular to the first side S1, confronting the base pivot portion 52. A first screw hole 62 extends from the first side S1 to a groove 63 (see FIG. 4) and is in alignment with the through-holes 433 and 436 of the holder pivot portion 43, as shown in FIG. 5. A second screw hole 65 extends through the second side S2 and is in alignment with the bore 524 of the base pivot portion 52, as shown in FIG. 7 or 8.

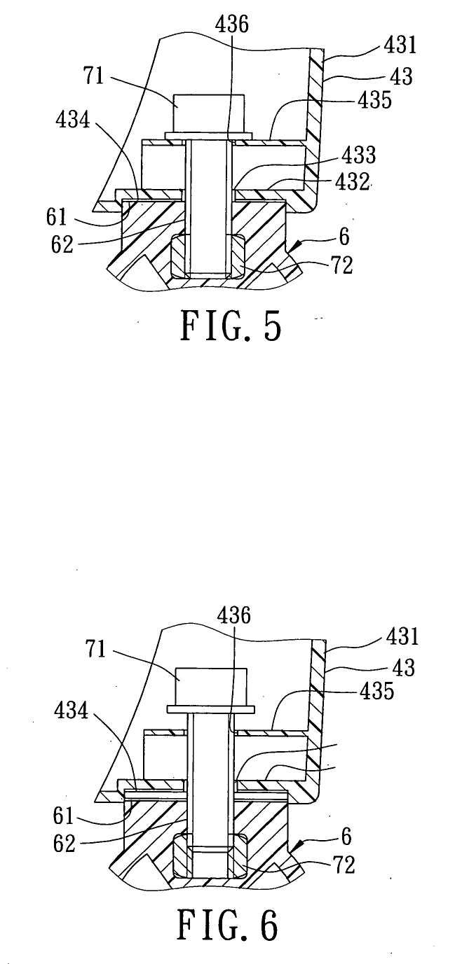

The first adjuster 7 connects the adjustment seat 6 to the holder pivot portion 43 by a first bolt 71 which extends into the through-holes 433,436 of the holder pivot portion 43 and the first screw hole 62 of the adjustment seat 6, and threadedly engages a first nut 72 received in the groove 63. The first adjuster 7 further includes a pair of interengageable first annular toothed members 61,434, one 61 provided on the first side S1 of adjustment seat 6, and the other 434 provided on the confronting side of the holder pivot portion 43. Accordingly, when the first bolt 71 and the nut 72 are tightened such that the head of the first bolt 71 presses against the rib plate 435 of the holder pivot portion 43 thus urging the first side S1 of the holder pivot portion 43 against the adjustment seat 6, the pair of first annular toothed members 61,434 interengage with one another thus fixing the mirror holder 4 to the adjustment seat 6, as shown in FIGS. 3 and 5. On the other hand, when the first bolt 71 is loosened from the first nut 72, the pair of first annular toothed members 61,434 will disengage from one another, and the holder pivot portion 43 is rendered rotatable relative to the adjustment seat 6 about a pivot axis defined by the first bolt 71, herein termed the first pivot axis, as shown in FIGS. 3 and 6. By such arrangement, therefore, the first adjuster 7 is operable to limit or permit rotational movement of the holder pivot portion 43 relative to the adjustment seat 6.

The second adjuster 8 connects the adjustment seat 6 to the base pivot portion 52 by a second bolt 81 which extends into the bore 524 of the base pivot portion 52 and the second screw hole 65 of the adjustment seat 6, and which is engaged threadedly by a second nut 82, as shown in FIG. 7. The second adjuster 8, like the first adjuster 7, includes a pair of interengageable annular toothed members 64,523, one 64 provided on the second side S2 of the adjustment seat 6, and the other 523 provided on the confronting side of the base pivot portion 52. Accordingly, when the second bolt 81 and the second nut 82 are tightened, the pair of second annular toothed members 64,523 interengage with one another thus fixing the adjustment seat 6 to the mounting base 5, as shown in FIGS. 4 and 7. On the other hand, when the second bolt 81 is loosened, the pair of second annular toothed members 64,523 will disengage from one another, and the base pivot portion 52 is rendered rotatable relative to the adjustment seat 6 about a pivot axis defined by the second bolt 81, herein termed the second pivot axis, which is substantially perpendicular to the first pivot axis, as shown in FIGS. 4 and 8. By such arrangement, therefore, the second adjuster 8 is operable to limit or permit rotational movement of the base pivot portion 52.

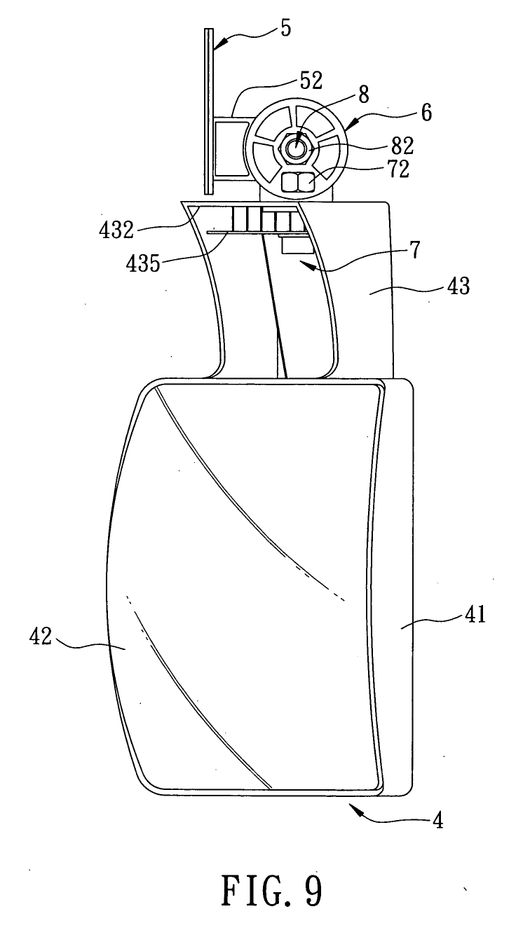

It can be appreciated, from the structural arrangement described above, that the present invention utilizes the adjustment seat 6 which cooperates with the mirror holder 4 and mounting base 5 in a matching design to allow the mirror holder 4 to be adjusted so that the mirror 42 can provide an optimum field of view as desired by a user, in particular a wide view of the ground at the rear of the automobile, through operation of the first and second adjusters 7,8. Referring to FIGS. 4 and 9, the tail mirror is reinforced such that upon installation (by pressing the adhesive layer 512 to a desired position at the rear of the automobile), the problem of possibly causing unfavorable adjustment to the optimum viewing angle is avoided. Further, the structural design of the tail mirror achieves not only the object of multi-angled adjustment of the mirror holder 4 but includes the least number of components such that the load problem after installation is overcome.

While the present invention has been described in connection with what is considered the most practical and preferred embodiment, it is understood that the present invention is not limited to the disclosed embodiment but is intended to cover various arrangements included within the spirit and scope of the broadest interpretation so as to encompass all such modifications and equivalent arrangements.

What is claimed is:

1. A tail mirror for an automobile, comprising:
a mirror holder including a holder pivot portion;
a mounting base having a base pivot portion;
an adjustment seat disposed between said holder and base pivot portions;
a first adjuster connecting said adjustment seat to said holder pivot portion, said holder pivot portion being rotatable relative to said adjustment seat about a first pivot axis, said first adjuster being operable to limit or permit rotational movement of said holder pivot portion; and
a second adjuster connecting said adjustment seat to said base pivot portion, said base pivot portion being rotatable relative to said adjustment seat about a second pivot axis substantially perpendicular to the said first pivot axis, said second adjuster being operable to limit or permit rotational movement of said base pivot portion.

2. The tail mirror of claim 1, wherein said mounting base further includes a support portion, said base pivot portion projecting from said support portion and extending between said support portion and said mirror holder, said adjustment seat and said base pivot portion being juxtaposed between said support portion and said mirror holder.

3. The tail mirror of claim 2, wherein said adjustment seat has a first side confronting said holder pivot portion and a second side confronting said base pivot portion.

4. The tail mirror of claim 3, wherein said first adjuster includes a first bolt which defines said first pivot axis and which extends into said holder pivot portion and said adjustment seat, and a first nut engaging said first bolt.

5. The tail mirror of claim 4, wherein said second adjuster includes a second bolt which defines said second pivot axis and which extends into said base pivot portion and said adjustment seat, and a second nut engaging said second bolt.

6. The tail mirror of claim 4, wherein said first adjuster further includes a pair of interengageable first annular toothed members provided respectively on said first side and said holder pivot portion, said first annular toothed members being disengageable from each other when said first bolt is loosened.

7. The rear mirror of claim 5, wherein said second adjuster further includes a pair of interengageable second annular toothed members provided respectively on said second side and said base pivot portion, said second annular toothed members being disengageable from each other when said second bolt is loosened.
